(19) United States
(12) Patent Application Publication
(10) Pub. No.: US 2017/0240062 A1
(43) Pub. Date: Aug. 24, 2017

(54) SYSTEM, METHOD AND STATION FOR DOCKING UNMANNED VEHICLES

(71) Applicant: SWARMX PTE. LTD., Singapore (SG)

(72) Inventors: Pulkit JAISWAL, Singapore (SG); Badrinarayanan RANGARAJAN, Singapore (SG)

(73) Assignee: SWARMX PTE. LTD., Singapore (SG)

(21) Appl. No.: 15/436,801

(22) Filed: Feb. 18, 2017

(30) Foreign Application Priority Data
Feb. 19, 2016 (SG) 10201601258U

(51) Int. Cl. B60L 11/18

(52) U.S. Cl. CPC B60L 11/1833; B60L 11/1835; B60L 11/1838; B60L 11/1818; B60L 2200/10; B60L 2200/32; B60L 2200/24

(57) ABSTRACT

The present invention relates to a system, method and station for docking unmanned vehicles. The system, method and station are particularly relevant, but not limited to dock the unmanned vehicles for autonomous operations. Further the system, method and station are particularly relevant, but not limited to protect the unmanned vehicles from external environments.

This application claims priority to the Singapore Patent Application No. 10201601258U filed on Feb. 19, 2016, the content of which is incorporated in its entirety herein.

### FIELD OF INVENTION

The present invention relates to a system, method and station for docking unmanned vehicles. The system, method and station are particularly relevant, but not limited to dock the unmanned vehicles for autonomous operations.

Background Art

The following discussion of the background to the invention is intended to facilitate an understanding of the present invention only. It should be appreciated that the discussion is not an acknowledgement or admission that any of the material referred to was published, known or part of the common general knowledge of the person skilled in the art in any jurisdiction as at the priority date of the invention.

The robotics technology has changed the world we live in. With the technological advances, unmanned aerial vehicles (UAVs), commonly known as drones, have mostly found military and special operation applications, but also are increasingly finding uses in civil applications, such as policing, surveillance and firefighting, and in enterprises, such as remote controlled toys and cameras.

Therefore, UAVs are an emerging technology that is being deployed in multiple role worldwide. However, despite the potential for the technology to revolutionize many standard processes, there is a limitation. This is mainly because UAV operations still require manual input from human operators, whether for maintenance or piloting for missions.

The operators of UAVs deploy on-site. They survey environments and plan the missions. After that, the UAVs take off and visit one or more set waypoints. However, in event of a low battery, the UAVs would need to return to the site to have their batteries manually swapped by human operators.

Further, the UAVs generate huge amount of data, e.g. video data, during flight of the UAVs. The UAVs are unable to process the video data during flight of the UAVs. Therefore, The UAVs and operators return to headquarters just to process and upload the data. The process and upload of data may involve memory cards manually swapped by the human operators.

Therefore, there exists a need for a solution to charge battery of the UAVs and process data without human's manual operation.

### SUMMARY OF THE INVENTION

Throughout the specification, unless the context requires otherwise, the word “comprise” or variations such as “comprises” or “comprising”, will be understood to imply the inclusion of a stated integer or group of integers but not the exclusion of any other integer or group of integers.

Furthermore, throughout the specification, unless the context requires otherwise, the word “include” or variations such as “includes” or “including”, will be understood to imply the inclusion of a stated integer or group of integers but not the exclusion of any other integer or group of integers.

The present invention seeks to protect a vehicle from external environments during docking the vehicle into a station. The present invention further seeks to charge a battery of the vehicle and process data of the vehicle in the station without human's manual operation.

In accordance with first aspect of the present invention there is a system for docking vehicles comprising: a vehicle operable to transmit a signal to a station, wherein the signal is related to a landing of the vehicle; and the station operable to dock the vehicle therein, wherein the station includes: a computing device operable to receive the signal from the vehicle; at least one door operable to be opened by the computing device in order that the vehicle could land on a landing platform inside the station; at least one actuator operable to move the vehicle to a predetermined position of the landing platform; and wherein the computing device is operable to control the at least one actuator to charge a battery of the vehicle when the vehicle is located in the predetermined position of the landing platform.

Preferably, the computing device is operable to data communicate with the vehicle and receive telemetry data from the vehicle, wherein the telemetry data includes the signal.

Preferably, the station further includes a marker on the landing platform; and the vehicle further includes a camera operable to detect a position of the marker, and the vehicle is operable to set a landing position on the landing platform based on the detected position of the marker.

Preferably, the marker includes at least one infrared (IR) beacon operable to flash at least one IR light in a predetermined sequence.

Preferably, the vehicle further includes a GPS receiver operable to compare at least one location data received from at least one GPS satellite, and the vehicle is operable to set the landing position on the landing platform based on the compared location data and the detected position of the marker.

Preferably, the computing device is operable to control to close the at least one door of the station when the vehicle lands on the landing platform.

Preferably, the station further includes a sensor operable to detect at least one external environment, and the computing device is operable to determine whether to open the at least one door based on the detected external environment.

Preferably, the at least one actuator is operable to move to push the vehicle to a centre of the landing platform.

Preferably, the at least one actuator includes at least one contact point and the at least one contact point is operable to contact at least one leg of the vehicle in order to charge the battery of the vehicle.

Preferably, the computing device is operable to start to charge the battery of the vehicle when the at least one door of the station is closed.

Preferably, the vehicle is operable to transmit status data to the computing device of the station, and the computing device is operable to stop to charge the battery of the vehicle when the battery is charged in a predetermined amount of charge.

Preferably, the computing device is operable to stop to charge the battery of the vehicle when the at least one door of the station is opened.

Preferably, the vehicle further includes a telemetry sensor operable to provide navigational data for the vehicle to fly a predetermined path.

Preferably, the vehicle is operable to transmit data to the computing device during flight of the vehicle, wherein the data includes at least one of the telemetry data and mission data.

Preferably, the vehicle is operable to transmit the telemetry data to the computing device and determine whether to transmit the mission data to the computing device depending on a mission during flight of the vehicle.

Preferably, the vehicle is operable to transmit the mission data to the computing device during charge of the vehicle.

Preferably, the vehicle further includes a transmitter operable to transmit the mission data to the computing device during flight of the vehicle.

Preferably, the station consists of a waterproof material in order to protect the vehicle from external environments.

In accordance with second aspect of the present invention there is a method for docking vehicles comprising: transmitting a signal from a vehicle to a station, wherein the signal is related to a landing of the vehicle; receiving the signal at a computing device of the station from the vehicle; opening at least one door by the computing device in order that the vehicle could land on a landing platform inside the station; moving the vehicle to a predetermined position of the landing platform by at least one actuator; and charging a battery of the vehicle using the at least one actuator when the vehicle is located in the predetermined position of the landing platform.

Preferably, the computing device is operable to data communicate with the vehicle and receive telemetry data from the vehicle, wherein the telemetry data includes the signal.

Preferably, the station further includes a marker on the landing platform; and the vehicle further includes a camera operable to detect a position of the marker, and the vehicle is operable to set a landing position on the landing platform based on the detected position of the marker.

Preferably, the marker includes at least one IR beacon operable to flash at least one IR light in a predetermined sequence.

Preferably, the vehicle further includes a GPS receiver operable to compare at least one location data received from at least one GPS satellite, and the vehicle is operable to set the landing position on the landing platform based on the compared location data and the detected position of the marker.

Preferably, the computing device is operable to control to close the at least one door of the station when the vehicle lands on the landing platform.

Preferably, the station further includes a sensor operable to detect at least one external environment, and the computing device is operable to determine whether to open the at least one door based on the detected external environment.

Preferably, the at least one actuator is operable to move to push the vehicle to a centre of the landing platform.

Preferably, the at least one actuator includes at least one contact point and the at least one contact point is operable to contact at least one leg of the vehicle in order to charge the battery of the vehicle.

Preferably, the computing device is operable to start to charge the battery of the vehicle when the at least one door of the station is closed.

Preferably, the vehicle is operable to transmit status data to the computing device of the station, and the computing device is operable to stop to charge the battery of the vehicle when the battery is charged in a predetermined amount of charge.

Preferably, the computing device is operable to stop to charge the battery of the vehicle when the at least one door of the station is opened.

Preferably, the vehicle further includes a telemetry sensor operable to provide navigational data for the vehicle to fly a predetermined path.

Preferably, the vehicle is operable to transmit data to the computing device during flight of the vehicle, wherein the data includes at least one of the telemetry data and mission data.

Preferably, the vehicle is operable to transmit the telemetry data to the computing device and determine whether to transmit the mission data to the computing device depending on a mission during flight of the vehicle.

Preferably, the vehicle is operable to transmit the mission data to the computing device during charge of the vehicle.

Preferably, the vehicle further includes a transmitter operable to transmit the mission data to the computing device during flight of the vehicle.

Preferably, the station consists of a waterproof material in order to protect the vehicle from external environments.

In accordance with third aspect of the present invention there is a station for docking vehicles comprising: a computing device operable to receive a signal from a vehicle wherein the signal is related to a landing of the vehicle; at least one door operable to be opened by the computing device in order that the vehicle could land on a landing platform inside the station; at least one actuator operable to move the vehicle to a predetermined position of the landing platform; and wherein the computing device is operable to control the at least one actuator to charge a battery of the vehicle when the vehicle is located in the predetermined position of the landing platform.

Preferably, the computing device is operable to data communicate with the vehicle and receive telemetry data from the vehicle, wherein the telemetry data includes the signal.

Preferably, the station further includes a marker on the landing platform to be detected by the vehicle so that the vehicle could set a landing position on the landing platform based on the detected position of the marker.

Preferably, the marker includes at least one infrared (IR) beacon operable to flash at least one IR light in a predetermined sequence.

Preferably, the computing device is operable to control to close the at least one door of the station when the vehicle lands on the landing platform.

Preferably, the station further includes a sensor operable to detect at least one external environment, and the computing device is operable to determine whether to open the at least one door based on the detected external environment.

Preferably, the at least one actuator is operable to move to push the vehicle to a centre of the landing platform.

Preferably, the at least one actuator includes at least one contact point and the at least one contact point is operable to contact at least one leg of the vehicle in order to charge the battery of the vehicle.

Preferably, the computing device is operable to start to charge the battery of the vehicle when the at least one door of the station is closed.

Preferably, the computing device is operable to receive status data of the vehicle from the vehicle and stop to charge the battery of the vehicle when the battery is charged in a predetermined amount of charge.

Preferably, the computing device is operable to stop to charge the battery of the vehicle when the at least one door of the station is opened.

Preferably, the computing device is operable to receive data from the vehicle during flight of the vehicle, wherein the data includes at least one of the telemetry data and mission data.

Preferably, the computing device is operable to receive the telemetry data from the vehicle and determine whether to receive the mission data from the vehicle depending on a mission during flight of the vehicle.

Preferably, the computing device is operable to receive the mission data from the vehicle during charge of the vehicle.

Preferably, the station consists of a waterproof material in order to protect the vehicle from external environments.

Other aspects of the invention will become apparent to those of ordinary skill in the art upon review of the following description of specific embodiments of the invention in conjunction with the accompanying figures or by combining the various aspects of invention as described above.

### BRIEF DESCRIPTION OF THE DRAWINGS

The present invention will now be described, by way of example only, with reference to the accompanying drawings, in which:

FIG. 1 illustrates a block diagram of a station in accordance with an embodiment of the invention.

FIG. 2 illustrates a block diagram of a vehicle in accordance with an embodiment of the invention.

FIG. 3 illustrates a flow diagram of a station in accordance with an embodiment of the invention.

FIGS. 4 and 5 illustrate examples of a station in accordance with embodiments of the invention.

FIGS. 6 and 7 illustrate examples of a landing platform in accordance with embodiments of the invention.

FIGS. 8 and 9 illustrate examples of actuators in accordance with embodiments of the invention.

### DESCRIPTION OF EMBODIMENTS OF THE INVENTION

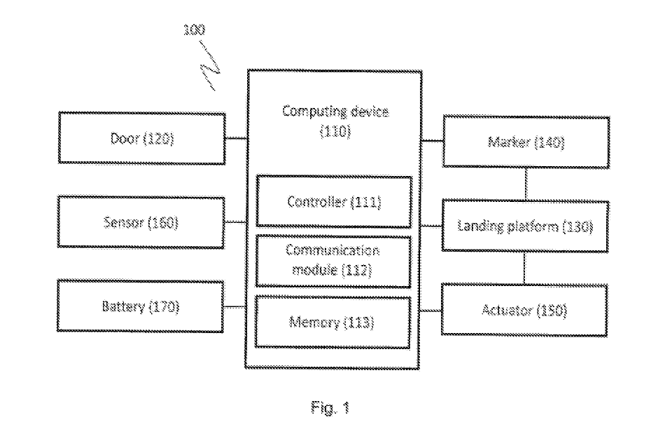

FIG. 1 illustrates a block diagram of a station in accordance with an embodiment of the invention.

In accordance with an embodiment of the invention and as shown in the FIG. 1, there is a station 100 for docking a vehicle 200 therein. The station 100 includes a computing device 110. The computing device 110 includes at least one controller 111, a communication module 112 and a memory 113.

The controller 111 is operable to control overall operations of the computing device 110 of the station 100. For example, the controller 111 controls the actuator 150 to charge a battery 260 of the vehicle 200 and processes data received from the vehicle 200.

The communication module 112 is operable to data communicate with vehicle 200 constantly and transmits/receives data to/from the vehicle 200. Particularly, the communication module 112 receives telemetry data and mission data from the vehicle 200 via at least one of wired and wireless communication. The telemetry data includes a signal related to a landing of the vehicle 200 and is radio at 915 MHz frequency. Further, the communication module 112 transmits/receives data to/from at least one network entities, e.g. base station, external device and server. Such data may represent at least one of audio, video, and text/multimedia message.

The communication module 112 supports internet access for the computing device 110 of the station 100. The communication module 112 may be internally or externally coupled to the computing device 110. The wireless Internet technology may include at least one of WLAN (Wireless LAN) (Wi-Fi), Wibro (Wireless broadband), Wimax (World Interoperability for Microwave Access), and HSDPA (High Speed Downlink Packet Access).

The memory 113 is used to store various types of data to support controlling and processing of the computing device 110. The memory 113 may be implemented using any type or combination of suitable volatile and non-volatile memory or storage devices including at least one of hard disk, random access memory (RAM), static random access memory (SRAM), electrically erasable programmable read-only memory (EEPROM), erasable programmable read-only memory (EPROM), programmable read-only memory (PROM), read-only memory (ROM), magnetic memory, flash memory, magnetic or optical disk, multimedia card micro type memory and card-type memory, e.g. SD memory or XD memory. The computing device 110 is able to operate in association with a web storage for performing a storage function of the memory 113 on internet.

The station 100 includes at least one door 120. The station 100 further includes a landing platform 130, a marker 140 and a sensor 160.

The door 120 (or shutter) is installed upper side of the station 100 and controlled by the computing device 110. When the computing device 110 receives a landing mode signal or a docking signal from the vehicle 200, the computing device 110 instructs the door 120 via at least one of electronic signal and electronic message to open in order to the vehicle 200 could land on the landing platform 130 inside the station 100. After that, the computing device 110 controls to close the door 120 when the vehicle 200 lands on the landing platform 130. Therefore, once the vehicle 200 lands in the station 100, the door 120 is closed, and the station 100 is able to protect the vehicle 200 from external environments, e.g. weather, and keep the vehicle 200 safe.

The sensor 160 is installed outside the station 100 and detects the external environments, e.g. weather. The sensor 160 includes a hydro-sensor. The computing device 110 determines whether to open the door 120 based on the detected external environment. For example, if it is detected to be raining, the computing device 110 controls to close the door 120. The door 120 stays closed except when launching missions and receiving the vehicle 200 or additional vehicle for docking. Therefore, the present invention prevents a build-up of debris falling into the station 100. If it is detected to stop raining, the computing device 110 controls the actuator 150 to start to open the door 120 at least partially without user's command.

The landing platform 130 (or landing plate) is inside the station 100 and controlled by the computing device 110. The landing platform 130 is located in the station 100. When the door 120 is opened, the vehicle 200 lands on the landing platform 130 inside the station 100.

The marker 140 is installed on the landing platform 130 and is a position identifier of the landing platform 130. The marker 140 includes at least one infrared (IR) beacon. The IR beacon flashes at least one IR light, e.g. IR light emitting diode (LED), in a predetermined sequence.

The vehicle 200 includes an IR camera 241 to detect a position of the IR beacon. The vehicle 200 sets a landing position on the landing platform 130 based on the detected position of the IR beacon. The vehicle 200 further includes a global positioning system (GPS) receiver 270 to compare at least one location data received from at least one GPS satellite. The vehicle 200 sets the landing position on the landing platform 130 based on both of the compared location data and the detected position of the IR beacon in order to land the vehicle 200 precisely.

In the alternative, although not shown, a device or human operator in the station 100 may catch the vehicle 200 with a net or a cable for landing of the vehicle 200, and then, the device or human operator may untangle the vehicle 200 on the landing plate 130.

In addition, the station 100 includes at least one actuator 150 that corrects the vehicle's 200 final position on the landing platform 130. The actuator 150 is mechanical actuator and also functions as conductive charging points. The actuator 150 may be located on the landing platform 130, outside the landing platform 130, or be included in the landing platform 130.

The actuator 150 moves the vehicle 200 to a predetermined position of the landing platform 130. Specifically, the actuator 150 includes two prongs that move in from either side of the vehicle 200 to push it to the centre of the landing platform 130. The two prongs have metallic contact points that contact at least one leg of the vehicle 200. The at least one leg also comprises at least one metallic contact point, the at least one metallic contact point for charging or facilitating charging of the battery 260 of the vehicle 200.

The computing device 110 controls a charging circuit to charge the battery 260 of the vehicle 200. The computing device 110 controls the actuator 150 to start to charge the battery 260 when the door 120 of the station 100 is closed. After that, when the door 120 is opened, the computing device 110 controls the actuator 150 to stop to charge the battery 260.

The vehicle 200 continually transmits status data of the vehicle 200 to the computing device 110 even while encase in the station 100. The computing device 110 controls the actuator 150 to stop to charge the battery 260 when the battery 260 is charged in a predetermined amount of charge. For example, the computing device 110 shuts off the actuator 150 based on the received status data when the battery 260 is fully charged.

Previous solutions required manual positioning of the vehicle 200 and battery swapping. The present invention uses a contact charging. The contact charging has a benefit over wireless charging because the contact charging does not expose a magnetic field which is able to interfere with a telemetry sensor 250 of the vehicle 200.

In the alternative, instead of contact charging via the actuator 150, wireless charging or battery swapping may be used to charge the battery 260. Alternatively, although not shown, a human operator is able to plug a charging cable into the vehicle 200 or refuel the vehicle 200 for petroleum-powered vehicle 200.

The station 100 further includes a battery 170. A size of the battery 170 of the station may be larger than a size of the battery 260 of the vehicle. The battery 170 of the station is able to provide its power to the battery 260 of the vehicle. The battery 170 within the station 100 provides power for operations while disconnected from a power source. The battery 170 includes at least one of an Acid Gel Mat (AGM) deep cycle battery, a lithium ion battery and a lithium polymer battery. The battery 170 is also able to be replaced by a generator that runs all the time. A power management system in the station 100 makes the station 100 compatible with electricity from wall sockets, generators or solar panels. Meanwhile, the station 100 is placed with a stable power supply, e.g. hydrogen fuel cell systems.

In addition, the computing device 110 receives at least one of the telemetry data and the mission data from the vehicle 200 during charging the battery 260. The computing device 110 receives the telemetry data in real time during both of flight and charging, and receives the mission data during charging. Meanwhile, the computing device 110 may receive both of the telemetry data and the mission data in real time during both of flight and charging. The computing device 110 processes the data in real time, converts the data into a small format, and transmits the data to the users via a local network or cloud. Meanwhile, the data may be uploaded to a cloud-based server for data processing.

Further, the computing device 110 determines how the data is sent depending on the users' infrastructure and budget. For example, for low-end users, the computing device 110 transmits processed data, e.g. small files, few kilobytes, via radio signals across large distances to the users. On the other hand, for high-end users who need live video data from the vehicles 200 may install high-bandwidth wireless or wired data infrastructure, and the computing device 110 transmits the live video data to the users in real time.

Traditionally, data would be collected only after the vehicle's 200 mission and then processed into usable information. The present invention is able to reduce the lag time between data acquisition and the information being presented to users.

Alternatively, although not shown, if there is no issues transmitting large amounts of data to the user's device from the vehicle 200 operations area, the computing device 110 may not process the data and the user's device may process data received from the vehicle 200.

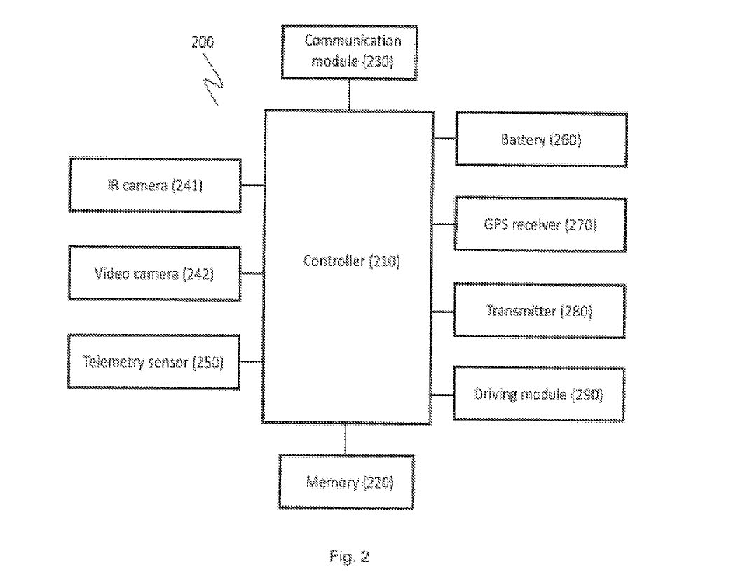

FIG. 2 illustrates a block diagram of a vehicle in accordance with an embodiment of the invention.

The vehicle 200 is not limited to unmanned aerial vehicles (UAVs), but may also be applicable to other autonomous devices that operate on the ground, such as unmanned ground vehicles (UGVs), or on the water, such as unmanned underwater vehicles (UUVs).

The vehicle 200 includes at least one of a controller 210, a memory 220, a communication module 230, an (infra-red) IR camera 241, a video camera 242 a telemetry sensor 250, a battery 260, a GPS receiver 270 and a driving module 290.

The controller 210 is operable to control overall operations of the vehicle 200. The driving module 290 generates driving power, and allows the vehicle 200 to take off and move in every direction. The driving module 290 includes at least one propeller and at least one motor. The battery 260 supplies power to the driving module 290. The telemetry sensor 250 provides navigational data for the vehicle 200 to fly properly, i.e. fly a predetermined path. The telemetry sensor 250 includes a compass.

The communication module 230 is operable to data communicate with computing device 110 of the station 100 constantly and transmits/receives data to/from the computing device 110. Further, the communication module 230 transmits/receives data to/from at least one network entities, e.g. base station, external device and server. Such data may represent at least one of audio, video, and text/multimedia message.

The communication module 230 supports internet access for the vehicle 200. The communication module 230 may be internally or externally coupled to the vehicle 200. The data is transmitted via wireless internet, e.g. Standard IEEE 802.11. The wireless Internet may include at least one of WLAN (Wireless LAN) (Wi-Fi), Wibro (Wireless broadband), Wimax (World Interoperability for Microwave Access), and HSDPA (High Speed Downlink Packet Access).

The vehicle 200 lands on the landing platform 130 of the station 100 using the IR camera 241 and the GPS receiver 270.

Specifically, the vehicle 200 includes the IR camera 241 to detect a position of the IR beacon on the landing platform 130. The vehicle 200 sets a landing position on the landing platform 130 based on the detected position of the IR beacon. In other words, the vehicle 200 repositions itself based on the detected position of the IR beacon, therefore, the vehicle 200 is able to land on top of the IR beacon.

The vehicle 200 further includes the GPS receiver 270 to compare at least one location data received from at least one GPS satellite. Regular GPS provides coordinates with accurate to tens of metres and this is insufficient to land the vehicle 200 precisely. Thus, the present invention uses a real time kinematics (RTK) GPS which compares a plurality of location data from a plurality of GPS satellites and is able to be accurate to within a few centimetres.

The vehicle 200 sets a landing position on the landing platform 130 based on both of the compared location data and the detected position of the IR beacon in order to land the vehicle 200 precisely. The combination of RTK GPS and IR guidance is able to minimize a precision landing error and is more cost effective than laser-based guidance. Furthermore, the combination is able to function both in high brightness day time and low brightness night time conditions. Because, the IR beacon is able to be detected with little interference from sunlight and is visible at night as it is an emitter of IR.

Although not shown, instead of the combination of the RTK GPS and the IR guidance, the vehicle 200 may use a laser guidance to land on the landing platform 130. Meanwhile, the landing platform 130 may have a geometry such that gravity may adjust the landing position of the vehicle 200 to the centre of the landing platform 130.

The vehicle 200 generates data including the telemetry data and the mission data. The camera 242, e.g. video camera, captures and generates mission data related to a mission. The memory 220 is used to store the data. The memory 220 may be implemented using any type or combination of suitable volatile and non-volatile memory or storage devices. The vehicle 200 is able to operate in association with a web storage for performing a storage function of the memory 220 on internet.

The telemetry data includes information at least one of GPS coordinates, heading, battery life, flight time and motor temperature of the vehicle 200. The mission data includes information from the vehicle's 200 cameras 242 and sensors. The telemetry data is light, e.g. few kilobytes, and constantly communicated to the computing device 110, i.e. both inflight and after landing. For example, the telemetry data includes a signal related to a landing of the vehicle 200 and is radio at 915 MHz frequency. On the other hand, the mission data is heavy, e.g. gigabyte, and may or may not be transmitted during flight.

Specifically, at least one of the computing device 110 and the vehicle 200 is able to determine whether to transmit the mission data to the computing device 110 during flight of the vehicle 200.

The vehicle 200 may transmit the mission data to the computing device 110 during charge of the vehicle 200 via at least one of wired and wireless communication.

Meanwhile, the vehicle 200 may transmit the mission data to the computing device 110 during flight of the vehicle 200 via wireless communication.

The vehicle 200 may further include a transmitter 280 in order to transmit the mission data to the computing device 110 during flight of the vehicle 200. It may depend on the mission. For example, live video data related to the security is transmitted to the computing device 110 during flight, and users are willing to pay for the transmitter 280. Meanwhile, data related to the agriculture is transmitted to the computing device 110 after the vehicle 200 has landed inside the station 100.

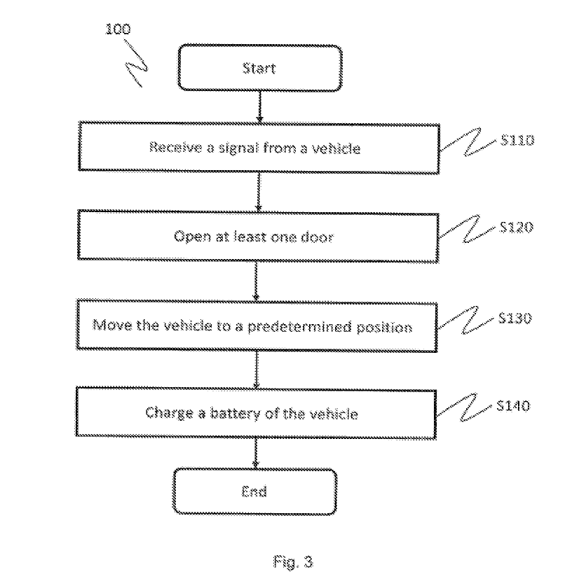

FIG. 3 illustrates a flow diagram of a station in accordance with an embodiment of the invention.

Firstly, the computing device 110 receives the signal from the vehicle 200 (S110). The signal is related to the landing of the vehicle 200. When the vehicle 200 changes its mode from the flight mode to the landing mode, the vehicle 200 transmits the signal to the station 100. Then, the computing device 110 of the station 100 receives the signal.

Then, the computing device 100 controls to open at least one door (S120) in order that the vehicle 200 could land on the landing platform 130 inside the station 100. The vehicle 200 recognizes the IR beacon on the landing platform 130 using the IR camera 241. Further, the vehicle 200 obtains a position information using the GPS receiver 270. After that, the vehicle 200 sets the landing position on the landing platform 130 and lands on the landing platform 130.

Even though the vehicle 200 lands on the landing platform 130 using the IR camera 241 and the GPS receiver 270, the vehicle 200 need to move a predetermined position in order to charge the battery 260 of the vehicle 200. The actuators 150 move the vehicle to the predetermined position (S130). The actuators 150 are two prongs having charging rails. As the actuators 150 move, the vehicle 200 also move to the predetermined position.

After that, the computing device 110 controls the actuator 150 to charge the battery 260 of the vehicle 200 (S140). The prongs of the actuators 150 have metallic contact points that contact to the metallic part of the vehicle 200. The computing device 110 is able to control the actuator 150 whether to charge the battery 260 based on the status of the vehicle 200 and state of the station 100, e.g. door 120 open and close.

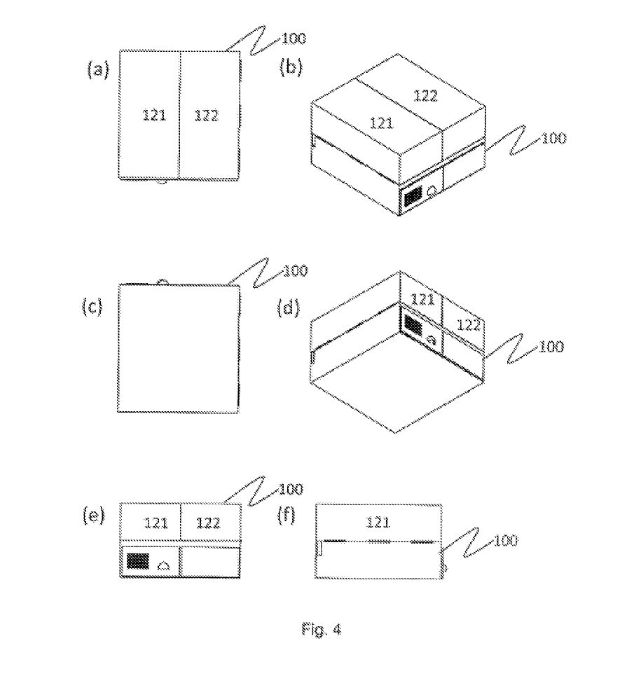

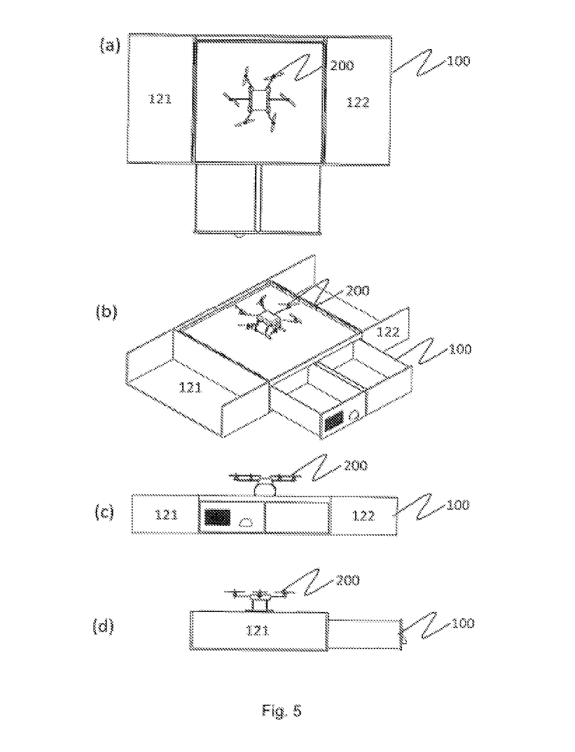

FIGS. 4 and 5 illustrate examples of a station in accordance with embodiments of the invention.

As shown in the FIGS. 4 and 5, there is a station 100 for docking a vehicle 200. The station 100 may allow that a vehicle 200 lands on the station 100. Although not shown, the station 100 may allow that only a predetermined vehicle 200, e.g. contracted vehicle, lands on the station 100. If the non-contracted vehicle transmits a landing signal or a docking signal to the station 100, the computing device 100 transmits a refusal signal to the non-contracted vehicle or controls not to open the door 120 of the station 100.

Meanwhile, the station 100 may allow that a plurality of vehicles or various types of vehicles land on the station 100. Although not shown, the station 100 may have a plurality of spaces for the plurality of vehicles.

As shown in the FIGS. 4 and 5, the size of the station 100 may be sufficient for the vehicle 200. In the alternative, although not shown, the size of the station 100 may be fit the size of the vehicle 200.

The shape of an external case of the station 100 is at least one of square and hexagon, but not limited to them. The station 100 consists of a waterproof material in order to protect the vehicle 200 from external environments. At least one door 120 (hereafter referred to the first and second door 121, 122) is installed upper side of the station 100 and also consists of the waterproof material. The first and the second door 121, 122 may be at least one of a sliding door or a hinge door.

The first and the second door 121, 122 are controlled by the computing device 110. The computing device 110 controls to close the first and the second door 121, 122 based on the external environment, e.g. weather. For example, if it is detected to be raining, the first and the second door 121, 122 are closed by the computing device 110. Moreover, if a solar panel is installed on the station 100 as the battery 170 of the station 100, the computing device 110 controls the first and the second door 121, 122 for recharging the solar panel.

As shown in the FIG. 4, the first and the second door 121, 122 are closed. When the computing device 110 receives a landing mode signal from the vehicle 200, the computing device 110 instructs the first and the second door 121, 122 via at least one of electronic signal and electronic message to open in order to the vehicle 200 could land on the landing platform 130 inside the station 100. Therefore, as shown in the FIG. 5, the first and the second door 121, 122 are opened.

After that, although not shown, the computing device 110 controls to close the first and the second door 121, 122 when the vehicle 200 lands on the landing platform 130.

Therefore, once the vehicle 200 lands in the station 100, the first and the second door 121, 122 are closed, and the station 100 is able to protect the vehicle 200 from the external environments, e.g. weather, and keep the vehicle 200 safe.

Although not shown, the computing device 110 may receive a take-off mode signal from the vehicle 200 or determine a take-off of the vehicle 200. In this case, the computing device 110 controls to open the at least one of the first and the second door 121, 122 for take-off of the vehicle 200. After the vehicle 200 takes off, the computing device 110 controls to close the at least one of the first and the second door 121, 122.

Meanwhile, the computing device 110 recognizes a type of the vehicle 200 and determines the number of doors to be opened. For example, if a size of the vehicle 200 is large, the computing device 110 may control to open both of the first and the second door 121, 122. On the other hand, if a size of the vehicle 200 is small, the computing device 110 may control to open one of the first and the second door 121, 122. Further, the computing device 110 may determine to open whether the first door 121 or the second door 122 based on a landing direction of the vehicle 200.

The station 100 is able to be deployed on-site in remote locations, e.g. at a gas pipeline that an oil company wants to monitor. A plurality of vehicles conduct surveillance anytime, since the plurality of vehicles are able to take turn to patrol the skies and replenish the power in the station 100.

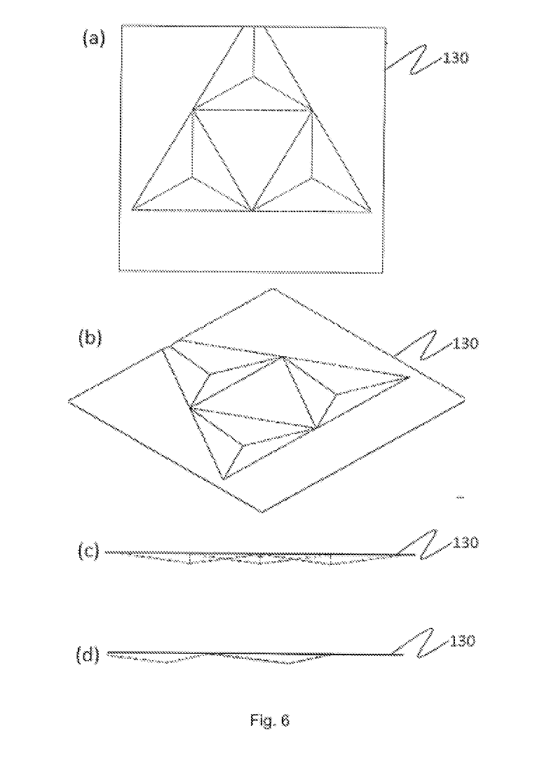

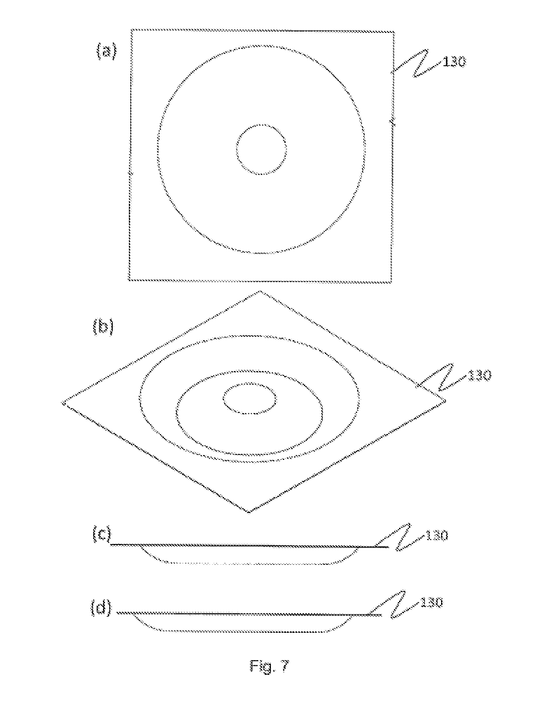

FIGS. 6 and 7 illustrate examples of a landing platform in accordance with embodiments of the invention.

The landing platform 130 (or landing plate) is inside the station 100 and controlled by the computing device 110. The landing platform 130 is located in a floor of the station 100. When the door 120 is opened, the vehicle 200 lands on the landing platform 130 inside the station 100. In the alternative, the landing platform 130 may be located in upper side of the station 100 and descend with the vehicle 200 into the station 100 when the vehicle 200 lands on the landing platform 130. Alternatively, although not shown, the landing platform 130 may be raised in order that the vehicle 200 lands on the landing platform 130 when the computing device 110 receives the landing signal from the vehicle 200.

Although not shown, the marker 140 is installed on the landing platform 130 and includes at least one IR beacon. The IR beacon flashes at least one IR light in a predetermined sequence, and the IR camera 241 of the vehicle 200 is able to recognize the IR beacon. Therefore, the vehicle 200 sets the landing position on the landing platform 130.

Meanwhile, as shown in the FIGS. 6 and 7, the landing platform 130 may have a geometry. The landing platform 130 has at least one slope inside. Therefore, even though the vehicle 200 is not located in the centre of the landing platform, the vehicle 200 slips into the centre of the landing platform 130. In other words, the gravity may adjust the landing position of the vehicle 200 to the centre of the landing platform 130.

Specifically, as shown in the FIG. 6, the landing platform 130 may have triangular funnels. If the vehicle 200 lands on the landing platform 130, the vehicle 200 slips into the centre of one of the triangular funnels. When the vehicle 200 is located in the centre of one of the triangular funnels, the computing device 110 controls the actuator 150 to start to charge the battery 260 of the vehicle 200.

As shown in the FIG. 7, the landing platform 130 may have a circular funnel. If the vehicle 200 lands on the landing platform 130, the vehicle 200 slips into the centre of the circular funnel. When the vehicle 200 is located in the centre of the circular funnel, the computing device 110 controls the actuator 150 to start to charge the battery 260 of the vehicle 200.

Although not shown, the landing platform 130 may have a cone funnel and a hemisphere funnel. The landing platform 130 may have a plurality of funnels, and a plurality of vehicles may lands on each of the plurality of funnels. The plurality of funnels may have different size each other for various types of the vehicles.

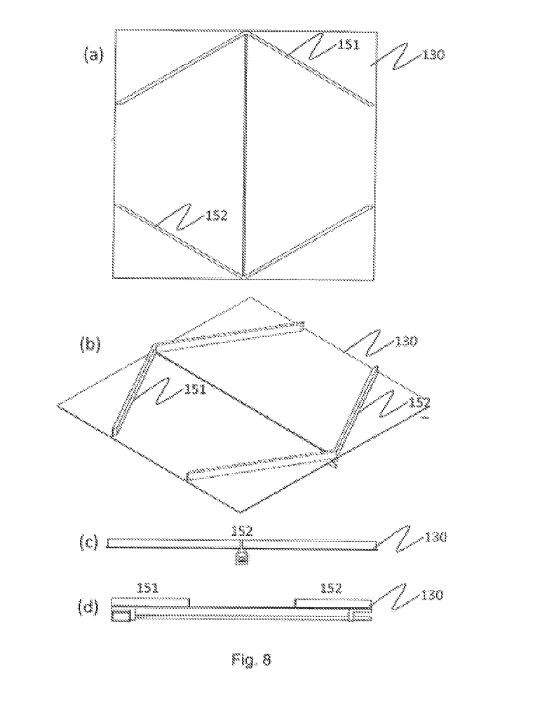

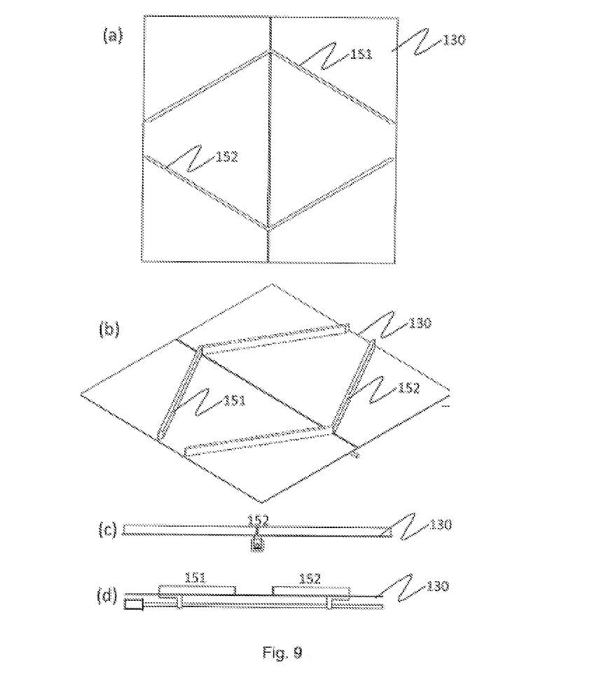

FIGS. 8 and 9 illustrate examples of actuators in accordance with embodiments of the invention.

As shown in the FIGS. 8 and 9, the station 100 includes at least one actuator 150 (hereafter referred to the first and second actuator 151, 152). The first and the second actuator 151, 152 may be located on the landing platform 130, be located outside the landing platform 130, or be included in the landing platform 130.

The first and the second actuator 151, 152 correct the vehicle's 200 final position on the landing platform 130. The actuators 150 are two prongs having guide rails.

As shown in the FIG. 8, the first and the second actuator 151, 152 are placed in a predetermined location. When the vehicle 200 lands on the landing platform 130, as shown in the FIG. 9, the first and the second actuator 151, 152 move in from either side of the vehicle 200 to push the vehicle 200 to the predetermined position, e.g. the centre of the landing platform 130.

After that, as described above, the first and the second actuator 151, 152 charge the battery 260 of the vehicle 200 by the computing device 110. Although not shown, after charging, the first and the second actuator 151, 152 may return to the predetermined location.

It should be appreciated by the person skilled in the art that variations and combinations of features described above, not being alternatives or substitutes, may be combined to form yet further embodiments falling within the intended scope of the invention.

1. A system for docking vehicles comprising:
a vehicle operable to transmit a signal to a station, wherein the signal is related to a landing of the vehicle; and
the station operable to dock the vehicle therein, wherein the station includes:
a computing device operable to receive the signal from the vehicle;
at least one door operable to be opened by the computing device in order that the vehicle could land on a landing platform inside the station;
at least one actuator operable to move the vehicle to a predetermined position of the landing platform; and
wherein the computing device is operable to control the at least one actuator to charge a battery of the vehicle when the vehicle is located in the predetermined position of the landing platform.

2-51. (canceled)
